(19) United States
(12) Patent Application Publication
(10) Pub. No.: US 2014/0222297 A1
(43) Pub. Date: Aug. 7, 2014

(54) DEVICE FOR SWITCHING BETWEEN A VEHICLE NAVIGATION SYSTEM AND A NIGHT VISION SYSTEM AS WELL AS SWITCHING METHOD THEREOF

(71) Applicant: SHENZHEN PROTRULY ELECTRONICS CO., LTD., Shenzhen (CN)

(72) Inventors: Min ZHUANG, Shenzhen (CN); Peng LU, Shenzhen (CN)

(73) Assignee: SHENZHEN PROTRULY ELECTRONICS CO., LTD., Shenzhen (CN)

(21) Appl. No.: 13/968,143

(22) Filed: Aug. 15, 2013

(30) Foreign Application Priority Data
Feb. 4, 2013 (CN) 201310043047.1

(51) Int. Cl. G01C 21/26

(52) U.S. Cl. CPC G01C 21/26
USPC 701/48

(57) ABSTRACT

The present invention discloses a device for switching between a vehicle navigation system and the night vision system as well as switching method thereof. The said device includes a navigation system switching module connects to the navigation system and a night vision system module connects to the night vision system, while both systems are connecting through video signal cable, and the switching modules are connecting through communication cable. Both switching modules are able to control any system switching into either mode, and transmit any info into either system then displaying the info. Therefore, the navigation system is also able to display night vision info and vice versa, which provides convenience to the users and improves the driving safety.

### CROSS-REFERENCES TO RELATED APPLICATIONS

This application claims the priority of Chinese patent application no. 201310043047.1, filed on Feb. 4, 2013, the entire contents of all of which are incorporated herein by reference.

### FIELD OF THE INVENTION

The present invention relates to the field of vehicle loaded multimedia technologies and, more particularly, to techniques on a device for switching between a vehicle navigation system and a night vision system as well as switching method thereof.

### BACKGROUND

In order to provide convenience to use and improve the driving safety, now vehicles are usually configured with a navigation system for driving route guidance and a night vision system to catch the figures ahead through far infrared thermal imaging in the evening or weak light driving conditions, which provides a better foreseen ability to the drivers. However, in prior art, the navigation system is installed separately from the night vision system, wherein, usually, the navigation system is installed in the control panel of the vehicle while the night vision system is hanging over head. Thus when the driver needs to obtain a clearer road conditions through the night vision system during night driving, the night vision display screen hanging overhead will not be convenient to watch, while when the passengers in the back seat want to check the navigation route, the navigation screen in the control panel is hard for them to watch, and this could affect the driver's driving. Due to the independence and non-compatibility between the navigation system and night vision system, it is inconvenient to use for both drivers and passengers, thus the usage rate is not high at all.

Therefore, the prior art needs to be improved and developed.

### BRIEF SUMMARY OF THE DISCLOSURE

The technical problem to be solved in the present invention is providing a device for switching between a vehicle navigation system and a night vision system as well as the switching method, aiming at the said defects of the prior art in inconvenient usage due to the incompatibility between the navigation system and the night vision system.

The technical solution adopted in the present invention to solve the technical problems is as below:

A device for switching between a vehicle navigation system and a night vision system, comprising: a navigation system switching module and a night vision system switching module;

The said navigation system switching module connects to a navigation system, configured to control the navigation system starting a navigation mode and displaying the navigation info, or control the navigation system starting a night vision mode and transmitting the night vision info from a night vision system to the navigation system before displaying, based on an input operation;

The said night vision system switching module connects to the night vision system, configured to control the night vision system starting a night vision mode and displaying the night vision info, or control the night vision system starting a navigation mode and transmitting the navigation info from the navigation system to the night vision system before displaying, based on the input operation;

The said navigation system connects to the night vision system through a video signal cable, configured to transmit the night vision info or navigation info between the navigation system and the night vision system;

The said navigation system switching module connects to the night vision system switching module through a communication cable, configured to transmit the according parameters of the navigation system or the night vision system to adjust the working status of the night vision system or the navigation system;

The said device for switching between the vehicle navigation system and the night vision system, wherein, the said video signal cable includes a navigation video signal cable and a night vision video signal cable;

The said navigation video signal cable connects to a camera of the navigation system, the navigation system and the night vision system, applied to transmit the navigation video signals collected by the camera of the navigation system to the navigation system, while the navigation system is in the navigation mode; or transmit the navigation video signals to the night vision system, while the night vision system is in the navigation mode;

The said night vision video signal cable connects to a camera of the night vision system, the navigation system and the night vision system, applied to transmit the night vision video signals collected by the camera of the night vision system to the night vision video system, when the night vision video system is in the night vision video mode; or transmit the night vision video signals to the navigation system, when the navigation system is in the night vision mode;

The said device for switching between the vehicle navigation system and the night vision system, wherein, the said navigation system switching module includes a first navigation switch button and a first night vision switch button; while the said first navigation switch button is used to control the navigation system starting the navigation mode, and the said first night vision switch button is used to control the navigation system starting the night vision mode;

The said night vision system switching module includes a second navigation switch button and a second night vision switch button; while the said second navigation switch button is used to control the night vision system starting the navigation mode, and the said second night vision switch button is used to control the night vision system starting the night vision mode;

The said device for switching between the vehicle navigation system and the night vision system, wherein, the said navigation system switching module also includes a first button detection circuit; while the said first button detection circuit connects to the first navigation switch button and the first night vision switch button separately, used to detect the using status of the first navigation switch button and the first night vision switch button;

The said night vision system switching module also includes a second button detection circuit; while the said second button detection circuit connects to the second navigation switch button and the second night vision switch button separately, used to detect the using status of the second navigation switch button and the second night vision switch button;

The said device for switching between the vehicle navigation system and the night vision system, wherein, the said navigation system switching module also includes a first judgment circuit; while the said first judgment circuit connects to the first button detection circuit, used to decide whether a mode switching is needed, based on the current navigation system mode, when the first navigation switch button or the first night vision switch button is pressed;

The said night vision system switching module also includes a second judgment circuit; while the said second judgment circuit connects to the second button detection circuit, used to decide whether a mode switching is needed, based on the current night vision system mode, when the second navigation switch button or the second night vision switch button is pressed.

A switching method for navigation system of a device for switching between a vehicle navigation system and a night vision system, comprises the following steps:
A. turn on the navigation system, initialize a navigation system switching module and start a navigation mode. A navigation video signal cable transmits navigation video signals collected by a camera of the navigation system to the navigation system for displaying;
B. real-time detect the using status of a switch button, if the switch button is detected to be pressed, judge if the pressed switch button is a first navigation switch button: if so, continue to step C; otherwise, go to step D;
C. judge if the mode of current navigation system is the navigation mode: if so, keep the current navigation mode unchanged; otherwise, switch a current night vision mode to the navigation mode, the navigation video signal cable then transmits navigation video signals collected by the camera of the navigation system to the navigation system for displaying, the navigation system starts the navigation mode;
D. ensure a first night vision switch button is pressed, judge if the current mode of the navigation system is a night vision mode: if so, keep the current night vision mode unchanged ; otherwise, switch the current navigation mode to the night vision mode, and a night vision video signal cable transmits night vision video signals collected by a camera of the night vision system to the navigation system for displaying, and the navigation system starts the night vision mode;

The said switching method for navigation system of the device for switching between the vehicle navigation system and the night vision system, wherein, when the navigation system starts the night vision mode, configure the according parameters for the night vision mode on a display screen of the navigation system, and adjust the working status of the night vision system.

A switching method for night vision system of a device for switching between a vehicle navigation system and a night vision system, comprises the following steps:
A. turn on a night vision system, initialize a night vision system switching module and start a night vision mode. A night vision video signal cable transmits night vision video signals collected by a camera of the night vision system to the night vision system for displaying;
B. real-time detect the using status of a switch button, if the switch button is detected to be pressed, judge if the pressed switch button is a second navigation switch button: if so, continue to step C; otherwise, go to step D;
C. judge if the current mode of the night vision system is a navigation mode: if so, keep the current navigation mode unchanged; otherwise, switch the current night vision mode to the navigation mode, a navigation video signal cable transmits navigation video signals collected by a camera of the navigation system to the night vision system for displaying, the night vision system starts the navigation mode;
D. ensure a second night vision switch button is pressed, judge if the current mode of the night vision system is the night vision mode: if so, keep the current night vision mode unchanged; otherwise, switch the current navigation mode to the night vision mode, and the night vision video signal cable transmits night vision video signals collected by the camera of the night vision system to the night vision system for displaying, and the night vision system starts the night vision mode;

The switching method for night vision system of the device for switching between the vehicle navigation system and the night vision system, wherein, when the night vision system starts the navigation mode, configure the according parameters for the navigation mode on the display screen of the night vision system, and adjust the working status of the navigation system.

The present invention provides a device for switching between the vehicle navigation system and the night vision system as well as switching method thereof. Controlling a navigation system starting a navigation mode and displaying the navigation info, or starting a night vision mode, and transmitting the night vision info from the night vision system to the navigation system for displaying, through a navigation system switching module; also, controlling the night vision system starting the night vision mode and displaying the night vision info, or starting the navigation mode, and transmitting the navigation info from the navigation system to the night vision system for displaying, through a night vision system switching module. Therefore, the navigation system is able to display the night vision info, and the night vision system is also able to display the navigation info, which provides convenience to users and improves the driving safety.

### BRIEF DESCRIPTION OF THE DRAWINGS

FIG. 1 illustrates a structure schematic diagram on a device for switching between a vehicle navigation system and a night vision system of a preferred embodiment of the present invention.

FIG. 2 illustrates a flow chart of a switching method for a navigation system on a device for switching between the vehicle navigation system and the night vision system in the present invention.

FIG. 3 illustrates a flow chart of a switching method of a night vision system on a device for switching between a vehicle navigation system and a night vision system in the present invention.

### DETAILED DESCRIPTION

In order to make the purpose, technical solution and the advantages of the present invention clearer and more definite, further detailed descriptions of the present invention are stated here, referencing to the attached drawings and some embodiments of the present invention. It should be understood that the detailed embodiments of the invention described here are used to explain the present invention only, instead of limiting the present invention.

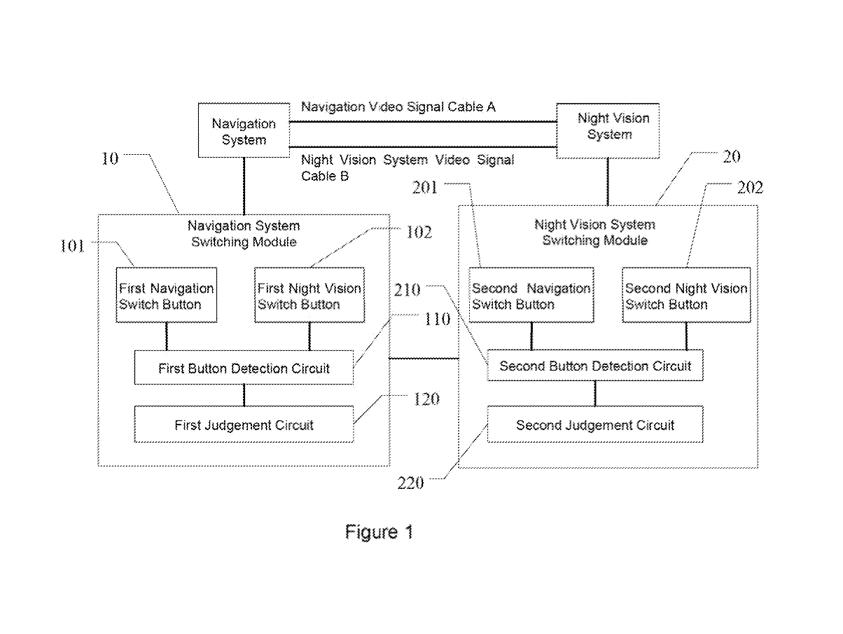

Refer to FIG. 1, which is a structure schematic diagram on a device for switching between a vehicle navigation system and a night vision system of a preferred embodiment of the present invention. As shown in FIG. 1, it includes a navigation system switching module 10 and a night vision system switching module 20. The said navigation system switching module 10 connects to a navigation system, applied to control the navigation system starting a navigation mode and displaying the navigation info, or control the navigation system starting a night vision mode, and transmitting the night vision info from a night vision system to the navigation system for displaying, based on the input operations. The said night vision system switching module 20 connects to the night vision system, applied to control the night vision system starting the night vision mode and displaying the night vision info, or control the night vision system starting the navigation mode, and transmitting the navigation info from the navigation system to the night vision system for displaying, based on the input operations.

Wherein, the navigation system connects to the night vision system through a video signal cable, applied to transmit the night vision info to the display screen of the navigation system for displaying, or transmit the navigation info to the screen of the night vision system for displaying. During the specific implementation, the said video signal cable includes a navigation video signal cable A, and a night vision video signal cable B. The said navigation video signal cable A connects to a camera of the navigation system, the navigation system and the night vision system together. When the navigation system is in the navigation mode, the navigation video signals collected by the navigation system camera, i.e., the road pictures ahead of the vehicle in the driving direction, taken by the camera, combining with the downloaded map, work together for route navigation. While the night vision system is in the navigation mode, the navigation video signals are transmitted to the night vision system through the navigation video signal cable A. Here, the only purpose of the navigation video signal cable A is transmitting the navigation video signals.

The said night vision video signal cable B connects to a camera of the night vision system, the navigation system and the night vision system together. When the night vision system is in the night vision mode, the night vision video signals collected by the camera of the night vision system, i.e., the road pictures ahead of the vehicle in the driving direction under a dark driving condition taken by the camera of the night vision system, which is then transmitted to the display screen of the navigation system for displaying, through the night vision video signal cable B. Where, the only purpose of the night vision video signal cable B is transmitting the night vision video signals.

The said navigation system switching module 10 connects to the night vision system switching module 20 through communication cable. Here, the said communication cable is a 485 cable, applied to transmit the according parameters of the night vision system or navigation system, and adjust the working status of the night vision system or navigation system. For example, when the navigation system starts the night vision mode, related parameters (such as exposure, light balance, focal length and so on) of the night vision system will be displayed on the display screen of the navigation system. After configuring these parameters, according control signals will be output and transmitted to the night vision system switching module 20 through the communication cable, and during the time to input the according control signals to the night vision system, it is able to control the camera of the night vision system to turn around, focus, or, adjust the light effects of the night vision pictures. The adjusted night vision video signals are transmitted to the navigation system for displaying, through the night vision video signal cable B; therefore, it is possible to control the night vision system from the display screen of the navigation system. Similarly, controlling the navigation system from the screen of the night vision system is also achievable.

In the present embodiment, the said navigation system switching module 10 includes a first navigation switch button 101 and a first night vision switch button 102. The said first navigation switch button 101 is configured to control the navigation system starting the navigation mode, while the said first night vision switch button 102 is applied to control the navigation system starting the night vision mode. The said night vision switching mode 20 includes a second navigation switch button 201 and a second night vision switch button 202. The said second navigation switch button 201 is applied to control the night vision system starting the navigation mode, and the second night vision switch button 202 is applied to control the night vision system starting the night vision mode.

Normally, when the navigation system is started, the system will start the navigation mode by default. If the user needs to switch to the night vision mode, then, just press the first night vision switch button 102, then the navigation system vision signal cable A will be shut off, and its connection to the navigation system will be shut down, thus the navigation video signals will be unable to transmit to the display screen of the navigation system for displaying; while the night vision video signal cable B will be connected to the navigation system, and transmitting the night vision video signals to the display screen of the navigation system for displaying. If the user needs to switch it back to the navigation mode, just press the first navigation switch button 101 and achieve the switching, and the navigation system video signal cable A will recover the connection with the navigation system, and shut off the connection of the night vision video signal cable B. Similarly, the working principles of the second navigation switch button 201 and the second night vision switch button 202 can be achieved.

In order to judge which of the above said buttons is pressed, further, the said navigation system switch module 10 also includes a first button detection circuit 110, which connects to the first navigation switch button 101 and the first night vision switch button 102 separately, applied to detect the using status of the first navigation switch button 101 and the first night vision switch button 102, i.e., whether they are pressed. The said night vision system switch module 20 also includes a second button detection circuit 210, which connects to the second navigation switch button 201 and the second night vision switch button 202, applied to detect the using status of the second navigation switch button 201 and the second night vision switch button 202.

When the switch button is pressed, it is also needed to combine the current mode to decide if it is needed to execute the function represented by the specific switch button. Further, the said navigation system switch module 10 also includes a first judgment circuit 120, which connects to the first button detection circuit 110, applied to decide if it is needed to switch the mode, based on the current navigation system mode, when the first navigation switch button 101 or the first night vision switch button 102 is pressed. The said night vision system switch module 20 also includes a second judgment circuit 220, which connects to the second button detection circuit 210, applied to decide if it is needed to switch the mode based on the current night vision system mode, when the second navigation switch button 201 or the second night vision switch button 202 is pressed.

Based on the above said embodiments, the embodiment of the present invention also provides a switching method for the device to switch between the vehicle navigation system and the night vision system.

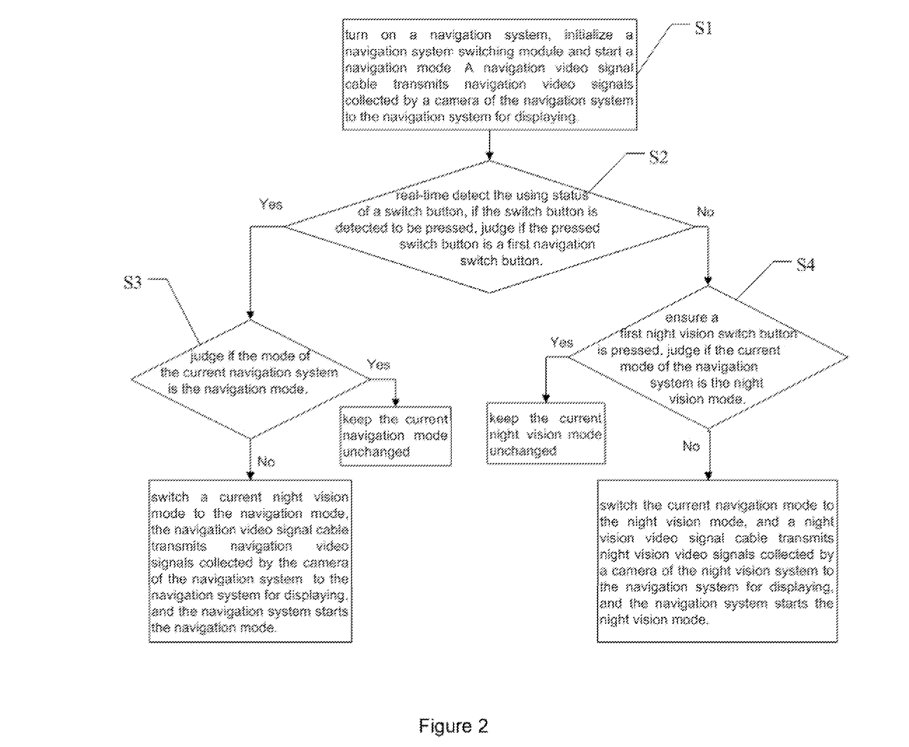

As shown in FIG. 2, the switching method of the navigation system comprises the following steps:

S1: turn on the navigation system, initialize the navigation system switching module and start the navigation mode. The navigation video signal cable transmits navigation video signals collected by the camera of the navigation system to the navigation system for displaying;

When the navigation system is started, the system will start the navigation mode by default.

S2: real-time detect the using status of the switch button, when the switch button is detected to be pressed, judge if the pressed switch button is the first navigation switch button: if so, continue to step S3; otherwise, go to step S4.

Real-time detect the using status of the switch buttons through the first button detection circuit, i.e., whether there are any switch buttons pressed, and which switch button is pressed.

S3: judge if the mode of current navigation system is the navigation mode: if so, keep the current navigation mode unchanged; otherwise, switch the current night vision mode to the navigation mode, the navigation video signal cable then transmits navigation video signals collected by the camera of the navigation system to the navigation system for displaying, and the navigation system starts the navigation mode;

S4: ensure the first night vision switch button is pressed, judge if the current mode of the navigation system is the night vision mode: if so, keep the current mode unchanged; otherwise, switch the current navigation mode to the night vision mode, and the night vision video signal cable transmits night vision video signals collected by the camera of the night vision system to the navigation system for displaying, and the navigation system starts the night vision mode.

The above mentioned step S2 and step S3 mainly point to the switch process when the first navigation switch button is pressed. Judge if it is needed to execute the function of the specific switch button, decided by the first judgment circuit combining the current mode. If the current mode is the navigation mode, then no switching operation is needed; if the current mode is the night vision mode, then pressing the first navigation switch button means switching the night vision mode to the navigation mode.

The above mentioned step S2 and step S4 mainly point to the switching process when the first night vision switch button is pressed. If the current mode is the night vision mode, then no switching operation is needed; if the current mode is the navigation mode, then pressing the first night vision switch button means switching the navigation mode to the night vision mode.

Further, when the navigation system starts the night vision mode, the according parameters of the night vision mode can be configured on the display screen of the navigation system, as well as the working status of the night vision system can be adjusted, that is, adjusting the brightness or light balance of the night vision pictures, as well as the focus, swinging of the camera, and more.

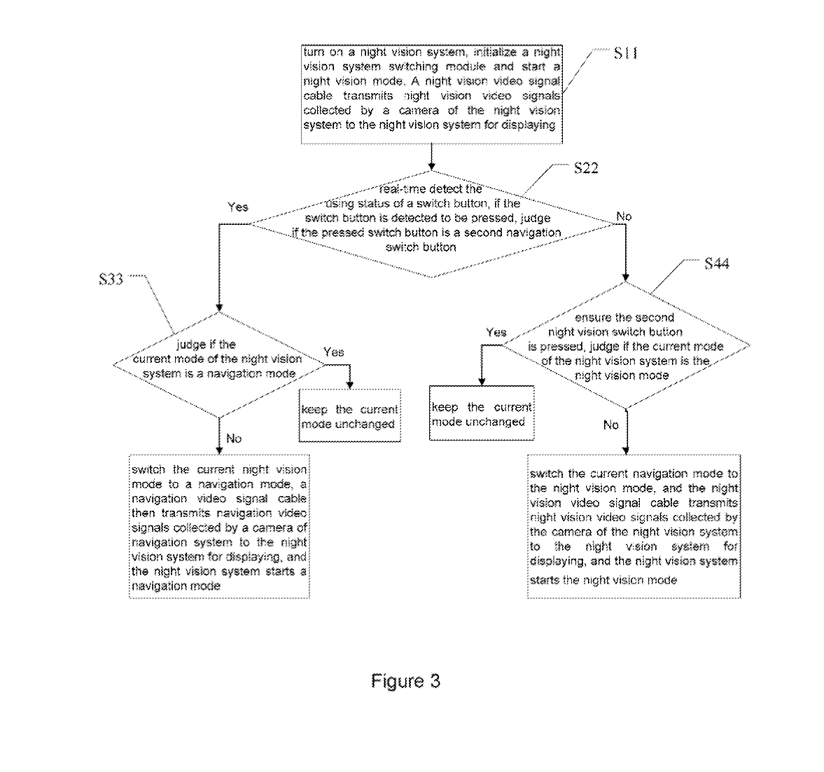

Similarly, the switching method of the night vision system can be achieved, as shown in FIG. 3, it comprises the following steps:

S11: turn on the night vision system, initialize the night vision system switching module and start the night vision mode. The night vision video signal cable transmits night vision video signals collected by the camera of the night vision system to the night vision system for displaying;

S22: real-time detect the using status of the switch button, if the switch button is detected to be pressed, judge if the pressed switch button is the second navigation switch button: if so, continue to step S33; otherwise, go to step S44.

Real-time detect the using status of the switch buttons through the second button detection circuit, i.e., whether there are any switch buttons pressed down, and which switch button is pressed down.

S33: judge if the current mode of the night vision system is the navigation mode: if so, keep the current mode without tranferring; otherwise, switch the current night vision mode to the navigation mode, the navigation video signal cable then transmits navigation video signals collected by the camera of the navigation system to the night vision system for displaying, the night vision system starts the navigation mode;

S44: ensure the second night vision switch button is pressed, judge if the current mode of the night vision system is the night vision mode: if so, keep the current mode unchanged; otherwise, switch the current navigation mode to the night vision mode, and the night vision video signal cable transmits night vision video signals collected by the the camera of the night vision system to the night vision system for displaying, and the night vision system starts the night vision mode.

Judge if it is needed to execute the function of the specific switch button, decided by the second judgment circuit combining the current mode. After the above mentioned switching operations, further, when the night vision system starts the navigation mode, the according parameters of the navigation mode can be configured on the display screen of the night vision system, in order to adjust the working status of the navigation system.

It should be understood that, the application of the present invention is not limited to the above examples listed. It will be possible for a person skilled in the art to make modifications or replacements according to the above description. All of these modifications or replacements shall all fall within the scope of the appended claims of the present invention.

What is claimed is:

1. A device for switching between a vehicle navigation system and a night vision system, wherein, it comprises: a navigation system switching module and a night vision system switching module:
The said navigation system switching module connects to a navigation system, configured to control the navigation system starting a navigation mode and displaying the navigation info, or control the navigation system starting a night vision mode and transmitting the night vision info from a night vision system to the navigation system before displaying, based on the input operation;
The said night vision system switching module connects to the night vision system, configured to control the night vision system starting a night vision mode and displaying the night vision info, or control the night vision system starting the navigation mode and transmitting the navigation info from the navigation system to the night vision system before displaying, based on the input operation;
The said navigation system connects to the night vision system through a video signal cable, configured to transmit the night vision info or the navigation info between the navigation system and night vision system; and
The said navigation system switching module connects to the night vision system switching module through a communication cable, configured to transmit the according parameters of the navigation system or the night vision system, and adjust the according working status of the night vision system or the navigation system.

2. The device for switching between the vehicle navigation system and the night vision system according to claim 1, wherein, the said video signal cable includes a navigation video signal cable and a night vision video signal cable;
The said navigation video signal cable connects to a camera of the navigation system, the navigation system and the night vision system together, applied to transmit the navigation video signals collected by the camera of the navigation system to the navigation system, when the navigation system is in the navigation mode; and transmit the navigation video signals to the night vision system, when the night vision system is in the navigation mode; and
The said night vision video signal cable connects to a camera of the night vision system, the navigation system and the night vision system together, applied to transmit the night vision video signals collected by the camera of the night vision system to the night vision system, when the night vision system is in the night vision mode; and transmit the night vision video signals to the navigation system, when the navigation system is in the night vision mode.

3. The device for switching between the vehicle navigation system and the night vision system according to claim 2, wherein, the said navigation system switching module includes a first navigation switch button and a first night vision switch button; while the said first navigation switch button is used to control the navigation system starting the navigation mode, and the said first night vision switch button is used to control the navigation system starting the night vision mode; and
The said night vision system switching module includes a second navigation switch button and a second night vision switch button; while the said second navigation switch button is used to control the night vision system starting the navigation mode, and the said second night vision switch button is used to control the night vision system starting the night vision mode.

4. The device for switching between the vehicle navigation system and the night vision system according to claim 3, wherein, the said navigation system switching module further comprises a first button detection circuit; while the said first button detection circuit connects to the first navigation switch button and the first night vision switch button separately, used to detect the using status of the first navigation switch button and the first night vision switch button; and
The said night vision system switching module further includes a second button detection circuit; while the said second button detection circuit connects to the second navigation switch button and the second night vision switch button separately, used to detect the using status of the second navigation switch button and the second night vision switch button.

5. The device for switching between the vehicle navigation system and the night vision system according to claim 4, wherein, the said navigation system switching module further includes a first judgment circuit; while the said first judgment circuit connects to the first button detection circuit, used to decide if the mode switching is needed based on the current navigation system mode, when the first navigation switch button or the first night vision switch button is pressed; and
The said night vision system switching module further includes a second judgment circuit; while the said second judgment circuit connects to the second button detection circuit, used to decide whether the mode switching is needed based on the current night vision system mode, when the second navigation switch button or the second night vision switch button is pressed.

6. A switching method for the navigation system of a device for switching between a vehicle navigation system and a night vision system, wherein, it comprises the following steps:
A. turn on a navigation system, initialize a navigation system switching module and start a navigation mode; A navigation video signal cable transmits navigation video signals collected by a camera of the navigation system to the navigation system for displaying;
B. real-time detect the using status of a switch button, if the switch button is detected to be pressed, judge if the pressed switch button is a first navigation switch button: if so, continue to step C; otherwise, go to step D;
C. judge if the mode of current navigation system is the navigation mode: if so, keep the current navigation mode unchanged; otherwise, switch a current night vision mode to the navigation mode, the navigation video signal cable transmits navigation video signals collected by the camera of the navigation system to the navigation system for displaying, and the navigation system starts the navigation mode; and
D. ensure a first night vision switch button is pressed, judge if the current mode of the navigation system is the night vision mode: if so, keep the current night vision mode unchanged; otherwise, switch the current navigation mode to the night vision mode, and the night vision video signal cable transmits night vision video signals collected by a camera of night vision system to the navigation system for displaying, and the navigation system starts the night vision mode.

7. The switching method for the navigation system of the device for switching between the vehicle navigation system and the night vision system according to claim 6, wherein, when the navigation system starts the night vision mode, configure the according parameters of the night vision mode on the display screen of the navigation system, and adjust the night vision system working status.

8. A switching method for a night vision system of a device for switching between a vehicle navigation system and a night vision system, wherein, it comprises the following steps:
a. turn on a night vision system, initialize a night vision system switching module and start a night vision mode; A night vision video signal cable transmits night vision video signals collected by a camera of the night vision system to the night vision system for displaying;
b. real-time detect the using status of a switch button, if the switch button is detected to be pressed, judge if the pressed switch button is a second navigation switch button: if so, continue to step C; otherwise, go to step D;
c. judge if the current mode of the night vision system is a navigation mode: if so, keep the current mode unchanged; otherwise, switch the current night vision mode to a navigation mode, a navigation video signal cable then transmits navigation video signals collected by a camera of navigation system to the night vision system for displaying, and the night vision system starts a navigation mode; and
d. ensure the second night vision switch button is pressed, judge if the current mode of the night vision system is the night vision mode: if so, keep the current mode unchanged; otherwise, switch the current navigation mode to the night vision mode, and the night vision video signal cable transmits night vision video signals collected by the camera of the night vision system to the night vision system for displaying, and the night vision system starts the night vision mode.

9. The switching method for the night vision system of the device for switching between the vehicle navigation system and the night vision system according to claim 8, wherein, when the night vision system starts the navigation mode, configure the according parameters of the navigation mode on the display screen of the night vision system, and adjust the working status of the navigation system.
